(19) United States
(12) Patent Application Publication
(10) Pub. No.: US 2024/0352219 A1
(43) Pub. Date: Oct. 24, 2024

(54) ARTIFICIAL HAIR AND METHODS OF MANUFACTURE

(71) Applicant: Hankook Wigfiber Co., LTD, Gimpo-si (KR)

(72) Inventor: HYUN JUNG HAN, Gimpo-si (KR)

(21) Appl. No.: 18/138,478

(22) Filed: Apr. 24, 2023

(51) Int. Cl. C08K 3/04; A41G 3/00; D01F 1/10

(52) U.S. Cl. CPC C08K 3/042; A41G 3/0083; D01F 1/103; C08K 2003/385

(57) ABSTRACT

The present specification discloses an improved artificial hair having a natural look and feel while minimizing tangling between individual strands of the artificial hair, along with associated methods of manufacture.

### RELATED APPLICATIONS

Not applicable.

### BACKGROUND

The subject of this patent application relates generally to artificial hair, and more particularly to improved artificial hair having a natural look and feel while minimizing tangling between individual strands of the artificial hair, along with associated methods of manufacture.

Applicant(s) hereby incorporate herein by reference any and all patents and published patent applications cited or referred to in this application.

By way of background, artificial hair integrations add length and fullness to human hair and are usually attached by clipping, adhering or sewing the integrations onto a person's existing natural hair. While some types of artificial hair integrations are constructed out of actual human hair (or hair from other animals), many others are constructed out of synthetic fibers as a lower cost alternative. Synthetic hair is typically made from nylon, polyester or acrylic, which is heated and subsequently extruded into strands to make individual hair fibers. The strands are then laced or tied into extensions or hairpieces. However, the relatively lower cost of synthetic hair integrations often results in relatively lower quality hair integrations, in light of the current materials that are used along with the methods of manufacturing the hair integrations.

For example, the strands of traditional synthetic hair integrations often become tangled when they are threaded with braiding or when incorporated into a full wig, which creates many difficulties with attaching the integrations or changing their shape. Additionally, in order to give a natural feeling or light diminishing property to synthetic hair integrations, the strands of synthetic material are often manufactured so as to be substantially triangular-shaped or Y-shaped in cross-section rather than circular-shaped in cross section. As a result, the strands of synthetic material may severely tangle, which could lead to the strands becoming damaged or cut when brushing or combing the hair integrations. In an attempt to solve these problems, the strands of synthetic material may be coated with a silicon or fluorine resin, through a spray or dipping process, in order to reduce the coefficient of friction between the strands of synthetic material. However, such coatings are typically not very durable and are often removed by shampoo or routine washing of the wearer's hair. Accordingly, there remains a need for synthetic hair integrations that have a natural look and feel while minimizing tangling between the individual strands.

Aspects of the present invention fulfill these needs and provide further related advantages as described in the following summary.

It should be noted that the above background description includes information that may be useful in understanding aspects of the present invention. It is not an admission that any of the information provided herein is prior art or relevant to the presently claimed invention, or that any publication specifically or implicitly referenced is prior art.

### SUMMARY

Aspects of the present invention teach certain benefits in construction and use which give rise to the exemplary advantages described below.

The present invention solves the problems described above by providing an improved artificial hair having a natural look and feel while minimizing tangling between individual strands of the artificial hair. In at least one embodiment, the artificial hair is comprised of about 99% to about 99.9% of a synthetic hair material, and about 0.1% to about 1% of a two-dimensional nanomaterial, based on the total volume of the composition.

In at least one embodiment, an exemplary method of manufacturing the artificial hair entails creating a mixture comprising about 99% to about 99.9% of a synthetic hair material, and about 0.1% to about 1% of a two-dimensional nanomaterial, based on the total volume of the composition; placing the mixture into a hopper of a hot melt extruder; and melting and extruding the mixture into a thread of artificial hair.

Other features and advantages of aspects of the present invention will become apparent from the following more detailed description, taken in conjunction with the accompanying drawings, which illustrate, by way of example, the principles of aspects of the invention.

### BRIEF DESCRIPTION OF THE DRAWINGS

The accompanying drawings illustrate aspects of the present invention. In such drawings:

FIGS. 1 and 2 are diagrammatic views of an exemplary improved artificial hair, in accordance with at least one embodiment;

FIG. 3 is a schematic view of an exemplary extruder used in manufacturing an exemplary improved artificial hair, in accordance with at least one embodiment; and

FIG. 4 is a flow diagram illustrating an exemplary method of manufacturing an exemplary improved artificial hair, in accordance with at least one embodiment.

The above described drawing figures illustrate aspects of the invention in at least one of its exemplary embodiments, which are further defined in detail in the following description. Features, elements, and aspects of the invention that are referenced by the same numerals in different figures represent the same, equivalent, or similar features, elements, or aspects, in accordance with one or more embodiments.

### DETAILED DESCRIPTION

The present specification discloses an improved artificial hair 20 along with associated methods of manufacture. In at least one embodiment, the artificial hair 20 is constructed out of a mixture of a synthetic hair material 22 and a two-dimensional nanomaterial 24 (i.e., a carbon material composed of covalent bonds of carbon atoms with a two-dimensional structure). In at least one embodiment, the mixture comprises about 0.1% to about 1% of the nanomaterial 24 along with about 99% to about 99.9% of the synthetic hair material 22, based on the total volume of the mixture. However, in further embodiments, the mixture may comprise more than 1% of the nanomaterial 24 and less than 99% of the synthetic hair material 22. As discussed further below, the nanomaterial 24 is added to the synthetic hair material 22 when the artificial hair 20 is produced (i.e., as an additive rather than a coating), and it serves as a softener to reduce the coefficient of friction and minimize entanglement between individual strands of the artificial hair 20 when the two-dimensional plate-shaped nanomaterial 24 particles are exposed to the fiber surface of the artificial hair 20. As a result, the individual strands of the artificial hair 20 are kept from becoming tangled together. Furthermore, because the nanomaterial 24 is integrated into the artificial hair 20 as opposed to being a coating, the efficacy of the nanomaterial 24 is not reduced through routine washing of the artificial hair 20.

In at least one embodiment, the synthetic hair material 22 is at least one of polyethylene terephthalate (“PET”), polypropylene (“PP”), acrylic, nylon, polyester, and polyvinyl chloride (“PVC”). However, in at least one alternate embodiment, the synthetic hair material 22 may be any other material (or combination of materials), now known or later developed, so long as the artificial hair 20 is capable of substantially carrying out the functionality described herein. Additionally, in at least one embodiment, the nanomaterial 24 is at least one of graphene and hexagonal boron nitride. However, in at least one alternate embodiment, the nanomaterial 24 may be any other materials (or combinations of materials), now known or later developed, so long as the artificial hair 20 is capable of substantially carrying out the functionality described herein.

In at least one embodiment, the nanomaterial 24 has a thickness of about 10 nanometers or less, along with a particle size of about 1.5 micrometers to about 2 micrometers. However, in further embodiments, the nanomaterial 24 may have a thickness of greater than 10 nanometers and/or a particle size that is smaller than 1.5 micrometers or larger than 2 micrometers.

In at least one embodiment, where the nanomaterial 24 is graphene, the resulting artificial hair 20 has been found to exhibit certain anti-bacterial properties. For example, where the artificial hair 20 contains at least 0.1% of graphene nanomaterial 24, based on the total volume of the artificial hair 20 mixture, the artificial hair 20 has been found to be 99.9% effective against certain bacteria such as staphylococcus and Streptococcus pneumoniae.

In at least one embodiment, in addition to the anti-tangle and anti-bacterial properties noted above, the resulting artificial hair 20 has also been found to exhibit improved elasticity as compared to traditional artificial hair (i.e., artificial hair that does not contain the nanomaterial 24), thereby allowing the artificial hair 20 to substantially return to its original shape even after being compressed or stretched for extended periods of time. This elastic quality of the artificial hair 20 was tested by comparing a strand of the artificial hair 20 (hereinafter referred to as the “artificial strand” for simplicity purposes) with a strand of traditional artificial hair (hereinafter referred to as the “traditional strand” for simplicity purposes).

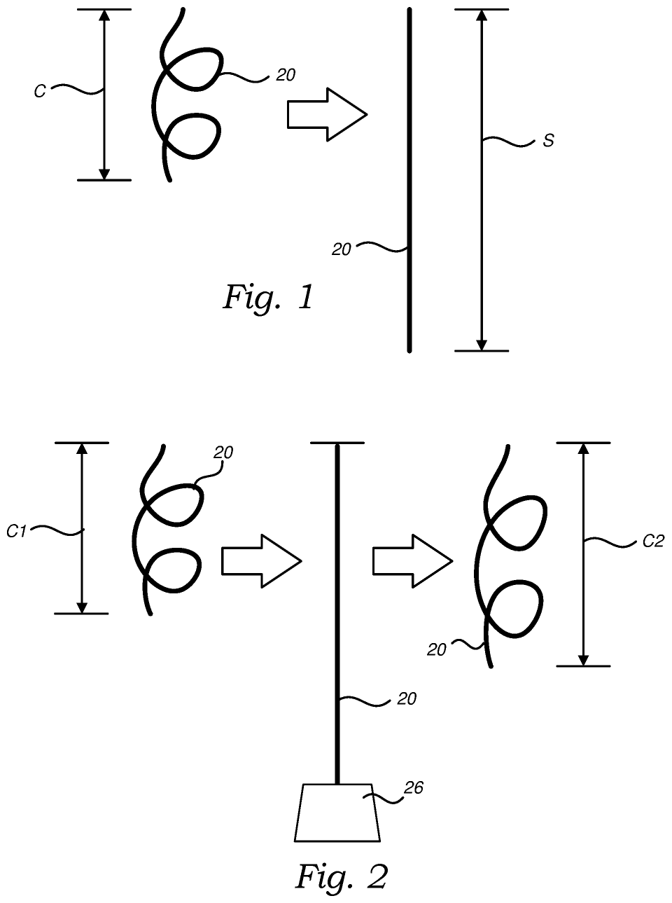

First, the curl formation capability of the artificial hair 20 was tested by applying a curl to each of the artificial strand and the traditional strand. As illustrated in FIG. 1, a curled length C was measured for each of the artificial strand and traditional strand while in a neutral curled state (i.e., neither compressed nor stretched). A stretched length S was then measured for each of the artificial strand and traditional strand while in a stretched state. A length contraction rate was then calculated for each of the artificial strand and traditional strand using the following formula:

$$\\ Length Contraction Rate ( \% ) = \frac{S - C}{S} \times 100$$

In each instance of the test, the length contraction rate for the artificial strand (averaging about 51.5%) was greater than the length contraction rate for the traditional strand (averaging about 38.5%), which means the artificial hair 20 was capable of retaining relatively larger curls, upon being curled, as compared to the traditional artificial hair.

Next, as illustrated in FIG. 2, the elastic recovery rate of the artificial hair 20 was tested by first measuring an initial curled length C1 for each of the artificial strand and traditional strand while in a neutral curled state (i.e., neither compressed nor stretched), then applying a load 26 of 100 grams to each of the artificial strand and traditional strand for a period of ten hours, at which point the load 26 was removed and a subsequent curled length C2 was measured for each of the artificial strand and traditional strand while in a neutral curled state. A deformation rate was then calculated for each of the artificial strand and traditional strand using the following formula:

$$\\ Deformation Rate ( \% ) = \frac{C 2 - C 1}{C 2} \times 100$$

In each instance of the test, the deformation rate for the artificial strand (averaging about 3.1%) was less than the deformation rate for the traditional strand (averaging about 12.1%), which means that the artificial hair 20 was capable recovering from being stretched and returning relatively closer to its original shape as compared to the traditional artificial hair.

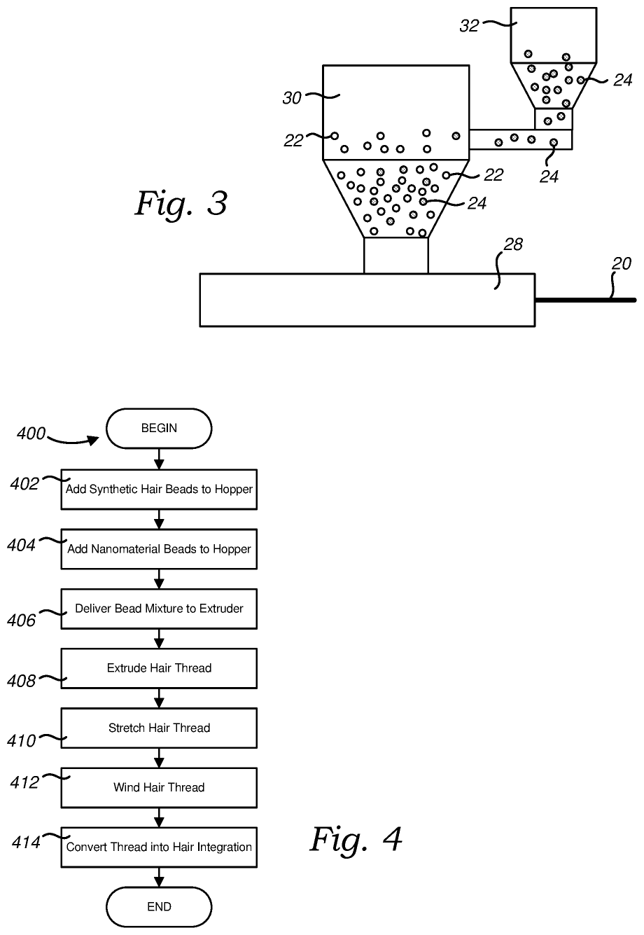

In at least one embodiment, as illustrated in FIG. 3, the artificial hair 20 is manufactured using a hot melt extruder 28 providing a primary hopper 30 in fluid communication with the extruder 28, along with a secondary hopper 32 in fluid communication with the primary hopper 30. In at least one embodiment, the secondary hopper 32 is positioned and configured for temporarily storing a volume of the nanomaterial 24, and delivering an appropriate volume of the nanomaterial 24 into the primary hopper 30. In an embodiment, the feeding of the nanomaterial 24 by the secondary hopper 32 to the primary hopper 30 is controlled by setting the rotation speed of an auger in the secondary hopper 32. The primary hopper 30, in turn, is configured for temporarily storing a volume of the synthetic hair material 22 along with the volume of nanomaterial 24 delivered from the secondary hopper 32, and delivering a uniform mixture of synthetic hair material 22 and nanomaterial 24 to the extruder 28, where the mixture is then extruded as a strand of artificial hair 20, as discussed further below. It should be noted that the extruder 28 illustrated in the schematic view of FIG. 3 is merely exemplary. As such, in further embodiments, the extruder 28, primary hopper 30 and secondary hopper 32 may each take on any other sizes, shapes, dimensions and relative positions, now known or later developed, so long as the extruder 28 is capable of assisting in the production of the artificial hair 20 described herein. In at least one alternate embodiment, forming the appropriate mixture of synthetic hair material 22 and nanomaterial 24 may be done using other methods or techniques, now known or later developed, with the mixture then being placed into the primary hopper 30, thereby omitting the need for the secondary hopper 32.

In at least one embodiment, each of the synthetic hair material 22 and nanomaterial 24 is configured as a plurality of granular units, such as chips, pellets, beads or a powder for example. For simplicity purposes, the term “bead” shall be used herein, and is intended to collectively refer to any sizes, shapes and/or configurations of the granular units of each of the synthetic hair material 22 and nanomaterial 24 used in the extruder 28. In at least one embodiment, the mixture of nanomaterial 24 beads and beads of synthetic hair material 22 in the primary hopper 30 contains a concentration of approximately 1% to 10% of the nanomaterial 24. However, in further embodiments, it is possible that the actual range may slightly deviate to a concentration less than 1% or greater than 10% of the nanomaterial 24.

In at least one embodiment, as illustrated in the flow diagram of FIG. 4, a method of manufacturing the artificial hair 20 first entails adding an appropriate volume of synthetic hair material 22 beads into the primary hopper 30 (402), and introducing an appropriate volume of nanomaterial 24 beads into the primary hopper 30 via the secondary hopper 32 (404). The mixture of synthetic hair material 22 beads and nanomaterial 24 beads is delivered to the extruder 28 via the primary hopper 30 (406), where the mixture is melted and extruded as a thread from an orifice of the extruder 28 (408). In at least one embodiment, the thread is stretched and heat-treated while passing through a conventional stretching process (410) and wound on a winder (412). In at least one alternate embodiment, after the extruder 28 forms the thread (408), the thread may be processed and converted into the artificial hair 20 using any other synthetic hair manufacturing methods, now know or later developed. The finished thread of artificial hair 20 is then converted into a desired type of hair integration (414)—for example, by being braided into a hair extension or developed into a full wig through a post-processing process.

Aspects of the present specification may also be described as the following embodiments:
1. An artificial hair composition comprising: about 99% to about 99.9% of a synthetic hair material, based on a total volume of the composition; and about 0.1% to about 1% of a two-dimensional nanomaterial, based on the total volume of the composition.
2. The artificial hair composition according to embodiment 1, wherein the synthetic hair material comprises at least one of polyethylene terephthalate, polypropylene, acrylic, nylon, polyester, and polyvinyl chloride.
3. The artificial hair composition according to embodiments 1-2, wherein the nanomaterial comprises at least one of graphene and hexagonal boron nitride.
4. The artificial hair composition according to embodiments 1-3, wherein the nanomaterial comprises graphene.
5. The artificial hair composition according to embodiments 1-4, wherein the nanomaterial has a thickness of about 10 nanometers or less.
6. The artificial hair composition according to embodiments 1-5, wherein the nanomaterial has a particle size of about 1.5 micrometers to about 2 micrometers.
7. The artificial hair composition according to embodiments 1-6, wherein the nanomaterial has a thickness of greater than 10 nanometers.
8. The artificial hair composition according to embodiments 1-7, wherein the nanomaterial has a particle size that is smaller than about 1.5 micrometers or larger than about 2 micrometers.
9. The artificial hair composition according to embodiments 1-8, wherein each of the synthetic hair material and nanomaterial is configured as a plurality of beads.
10. The artificial hair composition according to embodiments 1-9, wherein each bead of the nanomaterial contains a concentration of about 1% to about 10% of the nanomaterial.
11. The artificial hair composition according to embodiments 1-10, wherein each bead of the nanomaterial contains a concentration of less than 1% of the nanomaterial.
12. The artificial hair composition according to embodiments 1-11, wherein each bead of the nanomaterial contains a concentration of more than 10% of the nanomaterial.
13. An artificial hair composition comprising: about 99% to about 99.9% of a synthetic hair material comprising at least one of polyethylene terephthalate and polypropylene, based on a total volume of the composition; and about 0.1% to about 1% of graphene, based on the total volume of the composition.
14. A method of manufacturing an artificial hair comprising the steps of: creating a mixture comprising: about 99% to about 99.9% of a synthetic hair material, based on a total volume of the mixture; and about 0.1% to about 1% of a two-dimensional nanomaterial, based on the total volume of the mixture; placing the mixture into a hopper of a hot melt extruder; and melting and extruding the mixture into a thread of artificial hair.
15. The method according to embodiment 14, further comprising the step of stretching the thread of artificial hair.
16. The method according to embodiments 14-15, further comprising the step of winding the thread of artificial hair on a winder.
17. The method according to embodiments 14-16, further comprising the step of converting the thread of artificial hair into a desired hair integration.
18. The method according to embodiments 14-17, wherein the step of creating the mixture further comprises the steps of: placing the synthetic hair material into a primary hopper in fluid communication with the extruder; and placing the nanomaterial into a secondary hopper in fluid communication with the primary hopper.
19. The method according to embodiments 14-18, wherein the synthetic hair material comprises at least one of polyethylene terephthalate, polypropylene, acrylic, nylon, polyester, and polyvinyl chloride.
20. The method according to embodiments 14-19, wherein the nanomaterial comprises at least one of graphene and hexagonal boron nitride.
21. The method according to embodiments 14-20, wherein the nanomaterial comprises graphene.
22. The method according to embodiments 14-21, wherein the nanomaterial has a thickness of about 10 nanometers or less.
23. The method according to embodiments 14-22, wherein the nanomaterial has a particle size of about 1.5 micrometers to about 2 micrometers.
24. The method according to embodiments 14-23, wherein the nanomaterial has a thickness of greater than 10 nanometers.
25. The method according to embodiments 14-24, wherein the nanomaterial has a particle size that is smaller than about 1.5 micrometers or larger than about 2 micrometers.
26. The method according to embodiments 14-25, wherein each of the synthetic hair material and nanomaterial is configured as a plurality of beads.
27. The method according to embodiments 14-26, wherein each bead of the nanomaterial contains a concentration of about 1% to about 10% of the nanomaterial.
28. The method according to embodiments 14-27, wherein each bead of the nanomaterial contains a concentration of less than 1% of the nanomaterial.
29. The method according to embodiments 14-28, wherein each bead of the nanomaterial contains a concentration of more than 10% of the nanomaterial.

In closing, regarding the exemplary embodiments of the present invention as shown and described herein, it will be appreciated that an improved artificial hair having a natural look and feel while minimizing tangling between individual strands of the artificial hair, along with associated methods of manufacture, are disclosed. Because the principles of the invention may be practiced in a number of configurations beyond those shown and described, it is to be understood that the invention is not in any way limited by the exemplary embodiments, but is generally directed to an improved artificial hair and is able to take numerous forms to do so without departing from the spirit and scope of the invention. It will also be appreciated by those skilled in the art that the present invention is not limited to the particular geometries and materials of construction disclosed, but may instead entail other functionally comparable structures or materials, now known or later developed, without departing from the spirit and scope of the invention.

Certain embodiments of the present invention are described herein, including the best mode known to the inventor(s) for carrying out the invention. Of course, variations on these described embodiments will become apparent to those of ordinary skill in the art upon reading the foregoing description. The inventor(s) expect skilled artisans to employ such variations as appropriate, and the inventor(s) intend for the present invention to be practiced otherwise than specifically described herein. Accordingly, this invention includes all modifications and equivalents of the subject matter recited in the claims appended hereto as permitted by applicable law. Moreover, any combination of the above-described embodiments in all possible variations thereof is encompassed by the invention unless otherwise indicated herein or otherwise clearly contradicted by context.

Groupings of alternative embodiments, elements, or steps of the present invention are not to be construed as limitations. Each group member may be referred to and claimed individually or in any combination with other group members disclosed herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Unless otherwise indicated, all numbers expressing a characteristic, item, quantity, parameter, property, term, and so forth used in the present specification and claims are to be understood as being modified in all instances by the terms “about” and “approximately.” As used herein, the terms “about” and “approximately” mean that the characteristic, item, quantity, parameter, property, or term so qualified encompasses a range of plus or minus ten percent above and below the value of the stated characteristic, item, quantity, parameter, property, or term. Accordingly, unless indicated to the contrary, the numerical parameters set forth in the specification and attached claims are approximations that may vary. At the very least, and not as an attempt to limit the application of the doctrine of equivalents to the scope of the claims, each numerical indication should at least be construed in light of the number of reported significant digits and by applying ordinary rounding techniques. Notwithstanding that the numerical ranges and values setting forth the broad scope of the invention are approximations, the numerical ranges and values set forth in the specific examples are reported as precisely as possible. Any numerical range or value, however, inherently contains certain errors necessarily resulting from the standard deviation found in their respective testing measurements. Recitation of numerical ranges of values herein is merely intended to serve as a shorthand method of referring individually to each separate numerical value falling within the range. Unless otherwise indicated herein, each individual value of a numerical range is incorporated into the present specification as if it were individually recited herein. Similarly, as used herein, unless indicated to the contrary, the term “substantially” is a term of degree intended to indicate an approximation of the characteristic, item, quantity, parameter, property, or term so qualified, encompassing a range that can be understood and construed by those of ordinary skill in the art.

Use of the terms “may” or “can” in reference to an embodiment or aspect of an embodiment also carries with it the alternative meaning of “may not” or “cannot.” As such, if the present specification discloses that an embodiment or an aspect of an embodiment may be or can be included as part of the inventive subject matter, then the negative limitation or exclusionary proviso is also explicitly meant, meaning that an embodiment or an aspect of an embodiment may not be or cannot be included as part of the inventive subject matter. In a similar manner, use of the term “optionally” in reference to an embodiment or aspect of an embodiment means that such embodiment or aspect of the embodiment may be included as part of the inventive subject matter or may not be included as part of the inventive subject matter. Whether such a negative limitation or exclusionary proviso applies will be based on whether the negative limitation or exclusionary proviso is recited in the claimed subject matter.

The terms “a,” “an,” “the” and similar references used in the context of describing the present invention (especially in the context of the following claims) are to be construed to cover both the singular and the plural, unless otherwise indicated herein or clearly contradicted by context. Further, ordinal indicators-such as “first,” “second,” “third,” etc.—for identified elements are used to distinguish between the elements, and do not indicate or imply a required or limited number of such elements, and do not indicate a particular position or order of such elements unless otherwise specifically stated. All methods described herein can be performed in any suitable order unless otherwise indicated herein or otherwise clearly contradicted by context. The use of any and all examples, or exemplary language (e.g., “such as”) provided herein is intended merely to better illuminate the present invention and does not pose a limitation on the scope of the invention otherwise claimed. No language in the present specification should be construed as indicating any non-claimed element essential to the practice of the invention.

When used in the claims, whether as filed or added per amendment, the open-ended transitional term “comprising” (along with equivalent open-ended transitional phrases thereof such as “including,” “containing” and “having”) encompasses all the expressly recited elements, limitations, steps and/or features alone or in combination with un-recited subject matter; the named elements, limitations and/or features are essential, but other unnamed elements, limitations and/or features may be added and still form a construct within the scope of the claim. Specific embodiments disclosed herein may be further limited in the claims using the closed-ended transitional phrases “consisting of” or “consisting essentially of” in lieu of or as an amendment for “comprising.” When used in the claims, whether as filed or added per amendment, the closed-ended transitional phrase “consisting of” excludes any element, limitation, step, or feature not expressly recited in the claims. The closed-ended transitional phrase “consisting essentially of” limits the scope of a claim to the expressly recited elements, limitations, steps and/or features and any other elements, limitations, steps and/or features that do not materially affect the basic and novel characteristic(s) of the claimed subject matter. Thus, the meaning of the open-ended transitional phrase “comprising” is being defined as encompassing all the specifically recited elements, limitations, steps and/or features as well as any optional, additional unspecified ones. The meaning of the closed-ended transitional phrase “consisting of” is being defined as only including those elements, limitations, steps and/or features specifically recited in the claim, whereas the meaning of the closed-ended transitional phrase “consisting essentially of” is being defined as only including those elements, limitations, steps and/or features specifically recited in the claim and those elements, limitations, steps and/or features that do not materially affect the basic and novel characteristic(s) of the claimed subject matter. Therefore, the open-ended transitional phrase “comprising” (along with equivalent open-ended transitional phrases thereof) includes within its meaning, as a limiting case, claimed subject matter specified by the closed-ended transitional phrases “consisting of” or “consisting essentially of.” As such, embodiments described herein or so claimed with the phrase “comprising” are expressly or inherently unambiguously described, enabled and supported herein for the phrases “consisting essentially of” and “consisting of.”

Any claims intended to be treated under 35 U.S.C. § 112 (f) will begin with the words “means for,” but use of the term “for” in any other context is not intended to invoke treatment under 35 U.S.C. § 112 (f). Accordingly, Applicant reserves the right to pursue additional claims after filing this application, in either this application or in a continuing application.

It should be understood that the methods and the order in which the respective elements of each method are performed are purely exemplary. Depending on the implementation, they may be performed in any order or in parallel, unless indicated otherwise in the present disclosure.

All patents, patent publications, and other publications referenced and identified in the present specification are individually and expressly incorporated herein by reference in their entirety for the purpose of describing and disclosing, for example, the compositions and methodologies described in such publications that might be used in connection with the present invention. These publications are provided solely for their disclosure prior to the filing date of the present application. Nothing in this regard should be construed as an admission that the inventors are not entitled to antedate such disclosure by virtue of prior invention or for any other reason. All statements as to the date or representation as to the contents of these documents is based on the information available to the applicants and does not constitute any admission as to the correctness of the dates or contents of these documents.

While aspects of the invention have been described with reference to at least one exemplary embodiment, it is to be clearly understood by those skilled in the art that the invention is not limited thereto. Rather, the scope of the invention is to be interpreted only in conjunction with the appended claims and it is made clear, here, that the inventor(s) believe that the claimed subject matter is the invention.

What is claimed is:

1. An artificial hair composition comprising:
about 99% to about 99.9% of a synthetic hair material, based on a total volume of the composition; and
about 0.1% to about 1% of a two-dimensional nanomaterial, based on the total volume of the composition.

2. The artificial hair composition of claim 1, wherein the synthetic hair material comprises at least one of polyethylene terephthalate, polypropylene, acrylic, nylon, polyester, and polyvinyl chloride.

3. The artificial hair composition of claim 1, wherein the nanomaterial comprises at least one of graphene and hexagonal boron nitride.

4. The artificial hair composition of claim 3, wherein the nanomaterial comprises graphene.

5. The artificial hair composition of claim 1, wherein the nanomaterial has a thickness of about 10 nanometers or less.

6. The artificial hair composition of claim 5, wherein the nanomaterial has a particle size of about 1.5 micrometers to about 2 micrometers.

7. The artificial hair composition of claim 1, wherein each of the synthetic hair material and nanomaterial is configured as a plurality of beads.

8. The artificial hair composition of claim 7, wherein each bead of the nanomaterial contains a concentration of about 1% to about 10% of the nanomaterial.

9. An artificial hair composition comprising:
about 99% to about 99.9% of a synthetic hair material comprising at least one of polyethylene terephthalate and polypropylene, based on a total volume of the composition; and
about 0.1% to about 1% of graphene, based on the total volume of the composition.

10. A method of manufacturing an artificial hair comprising the steps of:
creating a mixture comprising:
about 99% to about 99.9% of a synthetic hair material, based on a total volume of the mixture; and
about 0.1% to about 1% of a two-dimensional nanomaterial, based on the total volume of the mixture;
placing the mixture into a hopper of a hot melt extruder; and
melting and extruding the mixture into a thread of artificial hair.

11. The method of claim 10, further comprising the step of stretching the thread of artificial hair.

12. The method of claim 11, further comprising the step of winding the thread of artificial hair on a winder.

13. The method of claim 10, wherein the step of creating the mixture further comprises the steps of:
placing the synthetic hair material into a primary hopper in fluid communication with the extruder; and
placing the nanomaterial into a secondary hopper in fluid communication with the primary hopper.

14. The method of claim 10, wherein the synthetic hair material comprises at least one of polyethylene terephthalate, polypropylene, acrylic, nylon, polyester, and polyvinyl chloride.

15. The method of claim 10, wherein the nanomaterial comprises at least one of graphene and hexagonal boron nitride.

16. The method of claim 15, wherein the nanomaterial comprises graphene.

17. The method of claim 10, wherein the nanomaterial has a thickness of about 10 nanometers or less.

18. The method of claim 17, wherein the nanomaterial has a particle size of about 1.5 micrometers to about 2 micrometers.

19. The method of claim 10, wherein each of the synthetic hair material and nanomaterial is configured as a plurality of beads.

20. The method of claim 19, wherein each bead of the nanomaterial contains a concentration of about 1% to about 10% of the nanomaterial.
